(19) United States
(12) Patent Application Publication
(10) Pub. No.: US 2011/0001280 A1
(43) Pub. Date: Jan. 6, 2011

(54) SHOCK ABSORBER AND SHOCK ABSORBING STRUCTURE FOR ABSORBING VIBRATION OF AN ARTICLE

(75) Inventor: TANG-HSIEN HUANG, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: MULTI-EXPANDER TECHNOLOGY INC., TAIPEI CITY (TW)

(21) Appl. No.: 12/573,321

(22) Filed: Oct. 5, 2009

(30) Foreign Application Priority Data
Jul. 3, 2009 (TW) 098212113

(51) Int. Cl. F16M 5/00

(52) U.S. Cl. 267/140.4

(57) ABSTRACT

A shock absorber for absorbing vibration of an article with respect to a stationary member, the article including a coupling element formed with a notch unit. The shock absorber includes an elastic sleeve member having an external surface to permit mounting of the coupling element there around via the notch unit, and a support post. The elastic sleeve member further has an axial hole. The support post is fixed on the stationary member, and extends through the axial hole in said elastic sleeve member. The support post has an intermediate section formed with an absorbing recess in alignment with an inner peripheral portion of the coupling element contacting the elastic sleeve member and confining the notch unit.

This application claims the benefits of the Taiwan Patent Application Serial NO. 098212113, filed on Jul. 3, 2009, the subject matter of which is incorporated herein by reference.

### BACKGROUND OF THE INVENTION

1. Field of the Invention

The present invention relates to a shock absorber and shock absorbing structure, more particularly to a shock absorber including an elastic sleeve member for absorbing the vibration of an article with respect to a stationary member.

2. Description of the Related Art

A shock absorber is generally applied, such as between a computer casing and a mother board or disk drive (or an exhaust and a motorbike body), during installation of a hard-disk device in an electronic apparatus. The purpose is to absorb the vibration of the article with respect to a stationary member such that the vibration does not affect operation of the electronic apparatus.

Generally speaking, one or several elastic pads or elastic springs are applied during installation of the hard-disk device. In other words, an elastic spring of suitable dimension can be disposed between a device to be prevented from being vibrated and the stationary member so as to absorb vibration of the device during the operation.

FIG. 1 shows a cross-sectional view of a conventional shock absorber while FIG. 1A shows a perspective view of the conventional shock absorber. As illustrated, the conventional shock absorber 90 includes a support post 91, an elastic sleeve member 92 and a coupler plate 93. The elastic sleeve member 92 is sleeved around the support post 91 while the coupler plate 93 is mounted on the sleeve member 92 in perpendicular to the support post 91. The coupler plate 93 has a circular central hole for mounting around the sleeve member 92 such that the conventional shock absorber 90 can absorb shock only in a single direction, i.e., along the horizontal direction. However, in our daily life, the vibration of an article is limited not only a single direction. For instance, when a man carries a computer set and walks, the computer set is subjected to vibrate simultaneously in the horizontal and vertical directions. Under this condition, the coupler plate 93 may fall off the elastic sleeve member 92 in the long run and fails to absorb the vibration in the vertical direction.

In the past, in order to absorb vibration in the multiple directions, several pieces of shock absorbers are implemented when installing a device with respect to a stationary member, thereby increasing the manufacturing cost and consequently causing inconvenience during the assembly.

Therefore, the main object of the present invention is to provide a new design for a shock absorber and a shock absorbing structure for utilizing during installation of a hard-disk device so that the problems encountered during use of the conventional shock absorber can be avoided.

### SUMMARY OF THE INVENTION

One aspect of the present invention is to provide a shock absorber and a shock absorbing structure for disposing between an article or device and a stationary member so as to absorb effectively the vibration in multiple directions, thereby enhancing operation of the device and prolonging the service life of the shock absorber produced according to the present invention.

The present invention relates to a shock absorber and a shock absorbing structure. The main purpose is to absorb the vibration of a device with respect to a stationary member. The shock absorbing structure accordingly includes a coupling element and a shock absorber. The coupling element is used for attaching to an article or device and is formed with a notch unit. The shock absorber includes an elastic sleeve member and a support post. The elastic sleeve member has an external surface to permit mounting of the coupling element there around via the notch unit. The elastic sleeve member further has a through hole to permit extension of the support post therethrough. The elastic sleeve member is made from elastic materials, such as rubber, sponge or springs.

The support post is fixed on the stationary member, and extends through the through hole in the elastic sleeve member, and has an intermediate section formed with an absorbing recess in alignment with an inner peripheral portion of the coupling element contacting the elastic sleeve member and confining the notch unit. The support post defines an axial hole formed with inner threads. The shock absorbing structure further includes a screw having a screw head abutting against an upper end of the support post and a threaded shaft extending into the axial hole and engaging the inner threads of the axial hole in the support post, thereby preventing movement of the elastic sleeve member in the vertical direction and mounting the same on the stationary member.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a cross-sectional view of a conventional shock absorber;

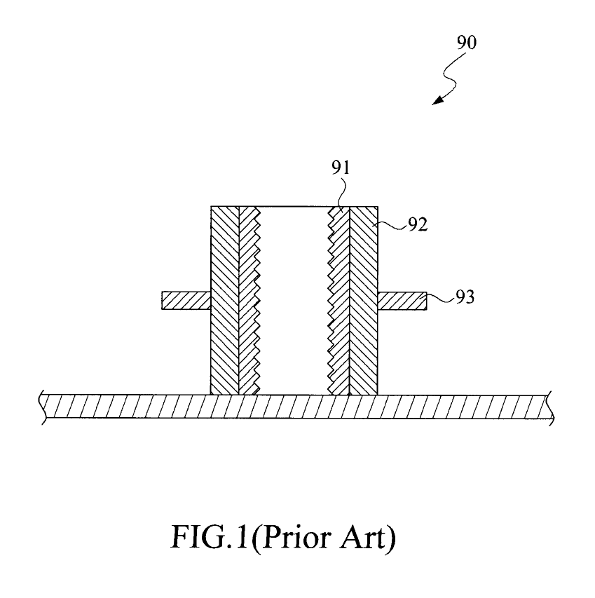

FIG. 1A shows a perspective view of the conventional shock absorber;

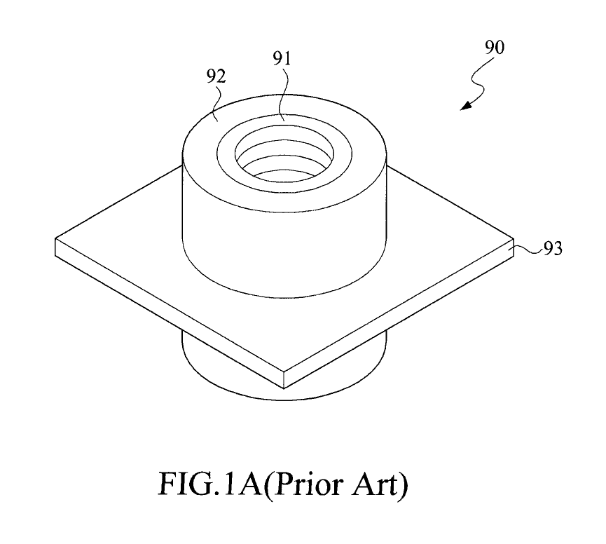

FIG. 2 illustrates a perspective view of a shock absorber or the shock absorbing structure implemented for mounting an article or device on a stationary member;

FIG. 3 illustrates an exploded view of a first embodiment of the shock absorber or the shock absorbing structure implemented for mounting the article or device on the stationary member;

FIG. 4 illustrates a perspective view of a second embodiment of the shock absorber or the shock absorbing structure implemented for mounting an article or device on a stationary member;

FIG. 5 is an exploded view of the shock absorber or the shock absorbing structure of the present invention;

FIG. 6 is a cross sectional view of the shock absorber or the shock absorbing structure of the present invention; and

FIG. 6A is a cross sectional view of the shock absorber or the shock absorbing structure of the present invention when impacted.

### DETAILED DESCRIPTION OF THE PREFERRED EMBODIMENTS

The shock absorber or shock absorbing structure of the present invention can be widely implemented in various apparatuses or between structures so as to absorb the vibration, the description thereof should not be limited to the following embodiments, since they are some examples illustrated for better understanding of the present invention.

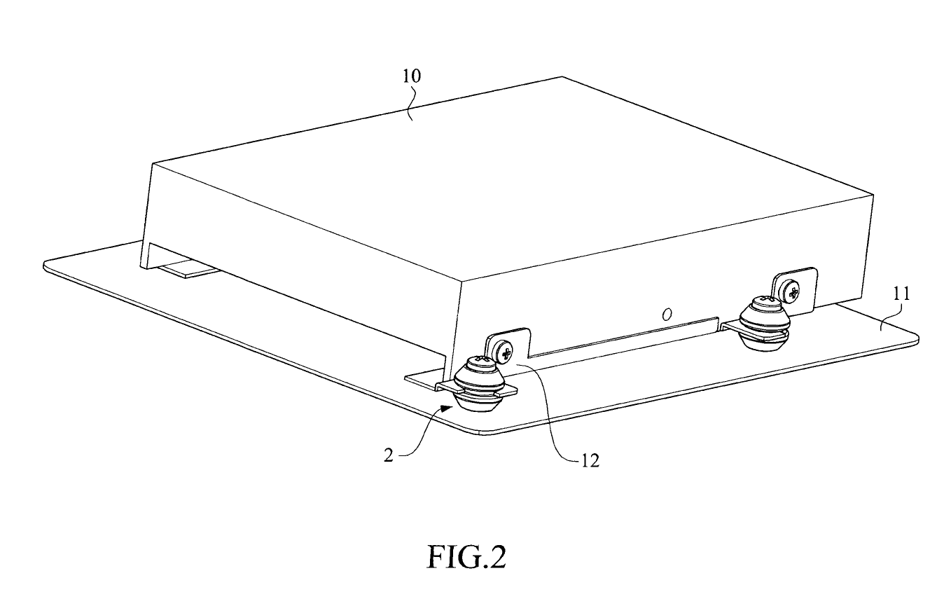

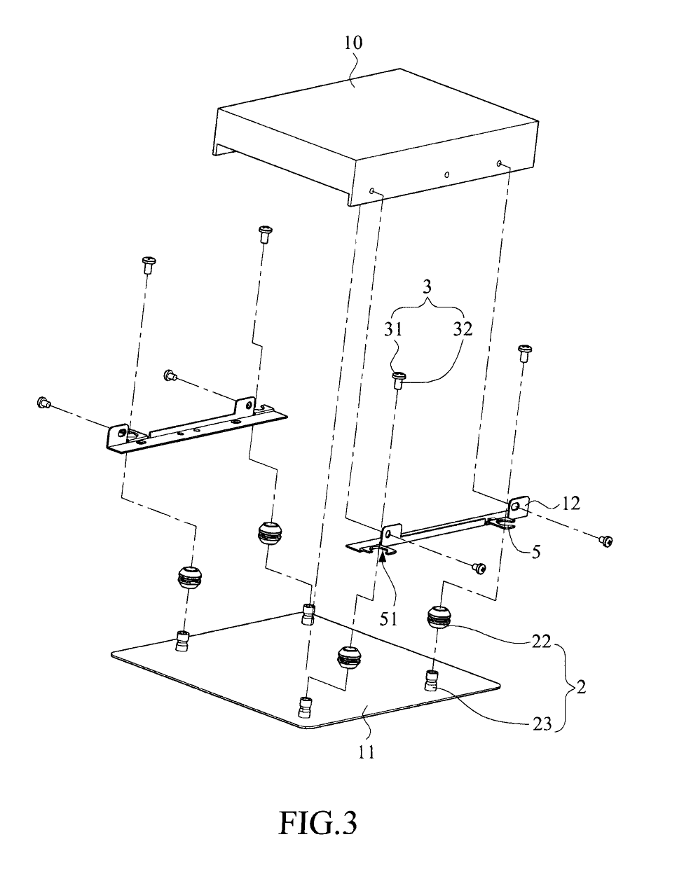

The shock absorber or shock absorbing structure 40 of the present invention is used for absorbing vibration of an article 10 with respect to a stationary member 11. FIG. 2 illustrates a perspective view of the shock absorber or the shock absorbing structure 40 implemented for mounting the article 10 or device on the stationary member 11. FIG. 3 illustrates an exploded view of a first embodiment of the shock absorber or the shock absorbing structure 40 implemented for mounting the article 10 or device on the stationary member 11.

As illustrated, the article 10 is a hard-disk device in a computer set while the stationary member 11 is a computer casing. The shock absorbing structure 40 of the present invention is installed between the hard-disk device 10 and the casing 11, and includes a shock absorber 2 and a coupling element. The shock absorber 2 includes an elastic sleeve member 22 and a support post 23. The coupling element illustrated in the FIG. 3, includes a coupling frame 12 having a mounting plate 5 formed with a notch unit 51.

The coupling frame 12 and the disk body 10 respectively have aligned screw holes to facilitate the assembly therebetween. The disk body 10 is located above and is fastened to the coupling frame 12 in a conventional manner. The elastic sleeve member 22 has an external surface to permit mounting of the coupling frame 12 there around via the mounting plate 5. The elastic sleeve member 22 further has a through hole 222. The support post 23 is fixed on the computer casing 11 and extends through the through hole 222 in the elastic sleeve member 22. The support post 23 has an intermediate section formed with an absorbing recess 231 in alignment with an inner peripheral portion of the mounting plate 5 contacting the elastic sleeve member 22 and confining the notch unit 51. In fact, the absorbing recess 231 is an annular recess.

Note that, the mounting plate 5 is formed with an opening extending through two opposite sides thereof. In this embodiment, the opening is constituted by the notch unit 51 and the inner peripheral portion confining the notch unit 51. To be more specific, the notch unit 51 occupies a quarter of the opening. The purpose of forming the notch unit 51 is to permit slight error and easy mounting and adjustment of the mounting plate 5 relative to the elastic sleeve member 22.

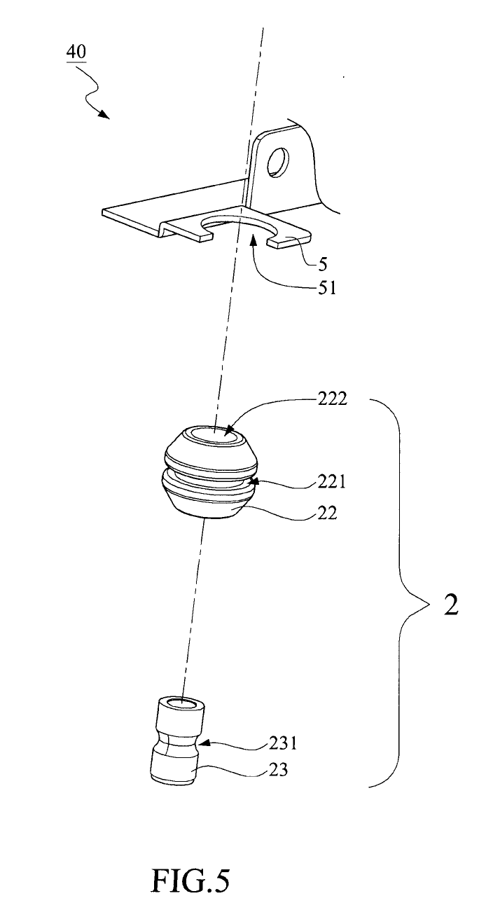

FIG. 5 is an exploded view of the shock absorbing structure 40 of the present invention. In this embodiment, the coupling frame 12 and the mounting plate 5 are formed by punching and bending operation. The opening and the notch unit 51 are punched through the mounting plate 5. In other words, the elastic sleeve member 22 can be pushed into the opening in the mounting plate 5 via the notch unit 51. Since the notch unit 51 occupies a quarter of the opening, the mounting plate 5 is prevented untimely removal from the elastic sleeve member 22.

In order to absorb the impact of vibration, the sleeve member 22 is made from elastic materials, such as rubber and sponge. As illustrated in FIG. 5, the through hole 222 in the sleeve member 22 is an axial hole having a lower end in contact with the computer casing 11. The external surface of the sleeve member 22 is formed with an annular groove 221 to permit extension of the inner peripheral portion of the mounting plate 5, thereby preventing vibration of the sleeve member 22 in the vertical direction, i.e., in the upward-and-downward direction with respect to the computer casing 11.

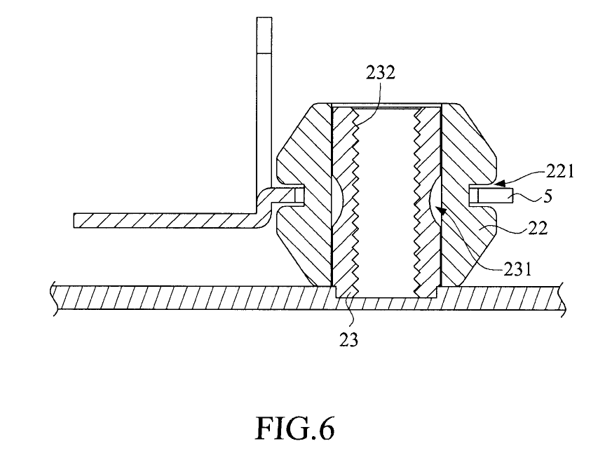

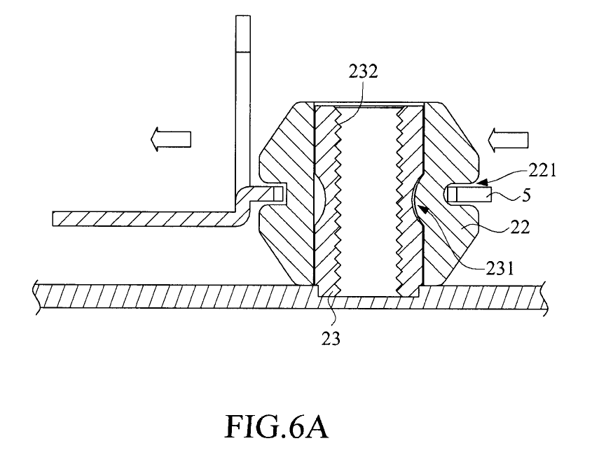

FIG. 6 is a cross sectional view of the shock absorbing structure 40 of the present invention. As illustrated, the support post 23 has an axial hole formed with inner threads 232. The shock absorbing structure 40 of the present invention further includes a fastener screw 3 (see FIG. 3) having a screw head 31 abutting against an upper end of the support post 23 and a threaded shaft 32 extending into the axial hole in the support post 23 and engaging the inner threads 232 of the axial hole in the support post 23.

After installation of the shock absorbing structure between the disk body 10 and the computer casing 11, the inner peripheral portion of the mounting plate 5 extends into and engages the annular groove 221 in the sleeve member 22. At this time, vibration of the sleeve member 22 in the vertical direction is prevented, i.e., in the upward-and-downward direction with respect to the computer casing 11. In time of vibration, a portion of the vibration in the horizontal and vertical directions is absorbed by the sleeve member 22 itself due to its elastic materials, thereby buffering and minimizing the vibration of the disk body 10.

FIG. 6A is a cross sectional view of the shock absorber or the shock absorbing structure of the present invention when impacted. As illustrated, in order to avoid solid or severe impact among the mounting plate 5, the sleeve member 22 and the support post 23 in the horizontal direction may cause damage to the support post 23, the intermediation portion of the support post 23 is spaced apart from the sleeve member by a gap (the annular recess 231), thereby allowing deformation of the sleeve member 22 in the horizontal direction in case the shock absorbing structure 40 is impacted in the horizontal direction. Under this condition, the support stand 23 is prevented from an actual impact along the horizontal direction.

Referring again to FIG. 3, in order to prevent untimely disengagement of the shock absorbing structure 40 from the disk body 10 and the computer casing 11 in the vertical direction, the fastener screw 3 is used to fasten the shock absorbing structure 40 on the computer casing 11. As to insertion of the fastener screw 3 into the support post 23 is already described in the preceding paragraphs, a detailed description of the same is omitted herein for the sake of brevity. After tightening the fastener screw 3 securely in the support post 23, the top end of the sleeve member 22 is slightly above the upper end of the support post 23 by virtue of the construction material of the sleeve member 22.

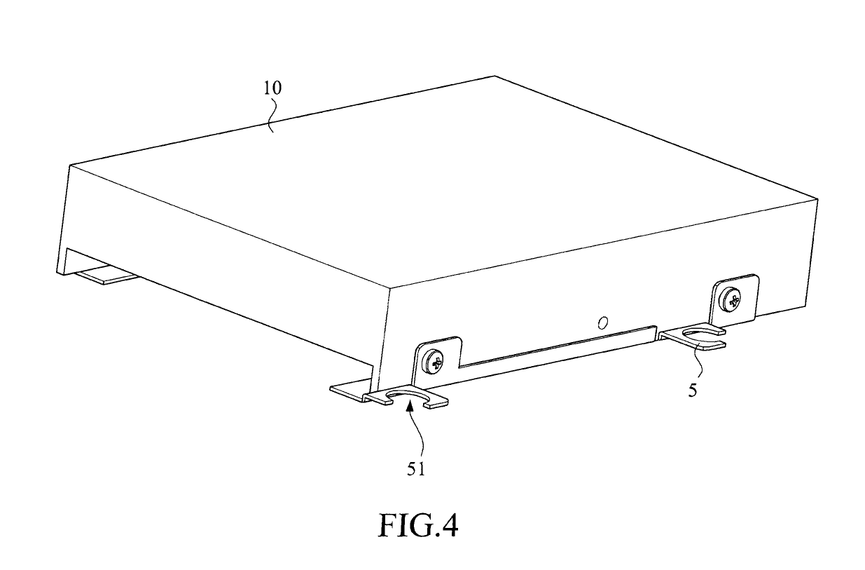

FIG. 4 illustrates a perspective view of a second embodiment of the shock absorbing structure of the present invention. As illustrated, in order to economize the material as well as construction cost, the coupling frame 12 can be deleted by directly installing four pieces of mounting plate 5 with the notch unit 51 at four appropriate positions of the disk body 10. In addition, hinges or clamp devices can be served for the mounting plates 5 so long as the device can be detachably fastened on the elastic sleeve member 22.

From the above-mentioned embodiments, one can easily understand the shock absorbing structure of the present invention. The shock absorbing structure is disposed between the disk body 10 and the computer casing 11, the annular recess and the annular groove in the support post and the sleeve member provide and absorb a relatively large amount of impact, thereby reducing and minimizing the vibration of the disk body 10.

By designing the annular groove in the external surface of the sleeve member 22 and the annular recess in the intermediate portion of the support post 23, absorbing the vibration of the disk body 10 along the horizontal and vertical directions can be achieved. The notch unit 51 in the mounting plate 5 facilitates assembly of the same on and detachment from the disk body 10.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A shock absorber for absorbing vibration of an article with respect to a stationary member, the article including a coupling element formed with a notch unit, the shock absorber comprising:
an elastic sleeve member having an external surface to permit mounting of the coupling element there around via the notch unit, said elastic sleeve member further having a through hole; and
a support post fixed on the stationary member and extending through said through hole in said elastic sleeve member, said support post having an intermediate section formed with an absorbing recess in alignment with an inner peripheral portion of the coupling element contacting said elastic sleeve member and confining the notch unit.

2. The shock absorber according to claim 1, wherein said absorbing recess in said support post is an annular recess.

3. The shock absorber according to claim 1, wherein said through hole in said elastic sleeve member is an axial hole having a lower end in contact with the stationary member, said support post having an axial hole formed with inner threads, the shock absorber further comprising a screw having a screw head abutting against an upper end of said support post and a threaded shaft extending into said axial hole and engaging said inner threads of said axial hole in said support post.

4. The shock absorber according to claim 1, wherein the coupling element includes a mounting plate having said notch unit and said inner peripheral portion formed therethrough, said external surface of said elastic sleeve member being formed with an annular groove to permit extension of said inner peripheral portion of said mounting plate, thereby installing said coupling element on said elastic sleeve member.

5. The shock absorber according to claim 4, wherein said notch unit and said inner peripheral portion cooperatively define an opening extending through two opposite sides of the mounting plate with said notch unit constituting a quarter of said opening.

6. A shock absorbing structure for absorbing vibration of an article with respect to a stationary member, comprising:
a coupling element for attaching to the stationary member and formed with a notch unit;
an elastic sleeve member having an external surface to permit mounting of said coupling element there around via the notch unit, said elastic sleeve member further having a through hole; and
a support post fixed on the stationary member and extending through said through hole in said elastic sleeve member, and having an intermediate section formed with an absorbing recess in alignment with an inner peripheral portion of said coupling element contacting said elastic sleeve member and confining the notch unit.

7. The shock absorbing structure according to claim 6, wherein said absorbing recess in said support post is an annular recess.

8. The shock absorbing structure according to claim 6, wherein said through hole in said elastic sleeve member is an axial hole having a lower end in contact with the stationary member, said support post having an axial hole formed with inner threads, the shock absorbing structure further comprising a screw having a screw head abutting against an upper end of said support post and a threaded shaft extending into said axial hole and engaging said inner threads of said axial hole in said support post.

9. The shock absorbing structure according to claim 6, wherein said coupling element includes a mounting plate having said notch unit and said inner peripheral portion formed therethrough, said external surface of said elastic sleeve member being formed with an annular groove to permit extension of said inner peripheral portion of said mounting plate, thereby installing said coupling element on said elastic sleeve member.

10. The shock absorbing structure according to claim 6, further comprising a coupling frame having two opposite ends respectively provided with said coupling element.

11. The shock absorbing structure according to claim 10, further comprising another coupling frame having two opposite ends respectively provided with said coupling element so as to be proximate to four corner of the article.

12. The shock absorbing structure according to claim 11, wherein said notch unit and said inner peripheral portion cooperatively define an opening extending through two opposite sides of the mounting plate with said notch unit constituting a quarter of said opening.
